(19) United States
(12) Patent Application Publication
(10) Pub. No.: US 2024/0065226 A1
(43) Pub. Date: Feb. 29, 2024

(54) Rubbing Device

(71) Applicant: SHENZHEN UAH TECHNOLOGY CO., LTD, Shenzhen (CN)

(72) Inventors: Qiang GENG, Shenzhen (CN); Shengbo LU, Shenzhen (CN); Weixin LUO, Shenzhen (CN); Cong WANG, Shenzhen (CN)

(73) Assignee: SHENZHEN UAH TECHNOLOGY CO., LTD, Shenzhen (CN)

(21) Appl. No.: 17/963,408

(22) Filed: Oct. 11, 2022

(30) Foreign Application Priority Data
Aug. 31, 2022 (CN) 202211055472.8

(51) Int. Cl. A01K 13/00

(52) U.S. Cl. CPC A01K 13/004

(57) ABSTRACT

Disclosed is a rubbing device. The rubbing device comprises a rotating drive part, a mounting post and a rubbing part provided with an inner hole. The rubbing part is rotatably installed on the mounting post through the inner hole; the rotating drive part is installed on the mounting post, positioned in the inner hole, and its output end is connected with the rubbing part; and the rotating drive part is used for driving the rubbing part to rotate to rub a to-be-rubbed object when the to-be-rubbed object scratches the rubbing part. In the present application, the rotating drive part can drive the rubbing part to rotate when the to-be-rubbed object scratches the rubbing part, so as to better rub the to-be-rubbed object.

### CROSS-REFERENCE TO RELATED APPLICATIONS

This application claims priority to Chinese Patent Application No. 202211055472.8, filed on Aug. 31, 2022, the entire content of which is incorporated herein by reference.

### TECHNICAL FIELD

The present application belongs to the technical field of pet supplies, in particular to a rubbing device.

### BACKGROUND

With the development of social economy and the acceleration of urbanization, more and more people like to live in their own small circles, and their interpersonal communication is becoming less and less. Pets such as cats and dogs can be people's friendly companions. These pets can not only help people get rid of loneliness in life, but also adjust people's mental health.

Cats are loved by people because of their gentle and cute characters. Therefore, more and more people are keeping cats at home. In the long-term raising process, cats need to comb their hair frequently to massage their bodies and get rid of aging hair. Usually, cats would actively look for corners, seats or chair legs to rub their backs.

In the prior art, back rubbing device can be used for rubbing to better relieve itching, i.e., cats rub their backs against the back rubbing device, and the convex structure on the back rubbing device can play a role in relieving the cat's mood and making the cat feel happy. However, the existing back rubbing device can only rub the cat's back passively, and its back rubbing performance is not satisfied.

### SUMMARY

The present application provides a rubbing device, aiming at the technical problem of unsatisfied back rubbing performance of the existing back rubbing device for cats.

In view of the above technical problem, the embodiments of the present application provide a rubbing device, including a rotating drive part, a mounting post and a rubbing part provided with an inner hole; the rubbing part is rotatably installed on the mounting post through the inner hole; the rotating drive part is installed on the mounting post, positioned in the inner hole, and an output end of the rotating drive part is connected with the rubbing part; and the rotating drive part is used for driving the rubbing part to rotate to rub a to-be-rubbed object when the to-be-rubbed object scratches the rubbing part.

Optionally, the rubbing device further includes a rotation direction recognition sensor installed on the mounting post; the rotation direction recognition sensor is used for detecting a rubbing direction of the to-be-rubbed object relative to the rubbing part; and when the rotation direction recognition sensor detects that the to-be-rubbed object scratches the rubbing part in a first direction, the rotating drive part drives the rubbing part to rotate in a second direction; and the first direction is opposite to the second direction.

Optionally, the mounting post is provided with a mounting hole and a through hole communicating with the mounting hole, the rotating drive part is installed in the mounting hole, and the output end of the rotating drive part passes through the through hole and is connected with the rubbing part; and the rubbing part further includes a battery installed in the mounting hole, and the battery is electrically connected with the rotating drive part.

Optionally, the rubbing device further includes an insertion cover installed at the output end of the rotating drive part, an insertion slot matched with the insertion cover is arranged on an inner wall of the inner hole, and the output end of the rotating drive part is connected with the rubbing part through the insertion cover inserted into the insertion slot.

Optionally, the rubbing device further includes a bearing sleeved on the mounting post, and the rubbing part is rotatably installed on the mounting post through the bearing.

Optionally, the rubbing device further includes a flexible ferrule sleeved on the mounting post, and the flexible ferrule is used for preventing the bearing from sliding along the mounting post.

Optionally, an outer surface of the rubbing part is provided with a plurality of arc grooves distributed at intervals.

Optionally, each arc groove is provided with a plurality of comb teeth distributed at intervals.

Optionally, the rubbing part is further provided with a storage tank, the rubbing device further includes a cover covering the storage tank, and the cover is further provided with a volatilization hole communicating with the storage tank.

Optionally, the rubbing device further includes a fixed part and a connecting arm connected with the mounting post, the fixed part is provided with a clamping arm, and the connecting arm is provided with a clamping groove, and the fixed part is detachably connected with the connecting arm through the clamping arm clamped in the clamping groove.

In the present application, the rubbing part is rotatably installed on the mounting post through the inner hole; and the rotating drive part is installed on the mounting post and positioned in the inner hole, and its output end is connected with the rubbing part. When the to-be-rubbed object does not scratch the rubbing part, the rotating drive part would not drive the rubbing part to rotate; when the to-be-rubbed object scratches the rubbing part, the rotating drive part would drive the rubbing part to rotate, and the rotating rubbing part would rub the body of the to-be-rubbed object, thus achieving the functions of rubbing the to-be-rubbed object, relieving the mood of the to-be-rubbed object, and delighting the mood of the to-be-rubbed object. In the present application, the rotating drive part can drive the rubbing part to rotate when the to-be-rubbed object scratches the rubbing part, so as to better rub the to-be-rubbed object. In addition, the rotating drive part is arranged in the inner hole of the rubbing part, and the mounting post can seal the inner hole from the lower end, thus preventing the external environment from infringing on the rotating drive part and prolonging the service life of the rubbing device. Moreover, the rubbing device has simple structure and low manufacturing cost.

### BRIEF DESCRIPTION OF THE DRAWINGS

The application is further illustrated with reference to the following drawings and

embodiments.

FIG. 1 is a structural schematic diagram of a rubbing device provided by an embodiment of the present application.

FIG. 2 is a sectional view of a rubbing device provided by an embodiment of the present application.

FIG. 3 is a schematic diagram of a part of the structure of a rubbing device provided by an embodiment of the present application.

FIG. 4 is a schematic diagram of a part of the structure of a rubbing device provided by an embodiment of the present application.

FIG. 5 is a structural schematic diagram of a rubbing part of a rubbing device provided by an embodiment of the present application.

Reference signs in the figures are as follows:

1. Rotating drive part; 2. Mounting post; 21. Mounting hole; 3. Rubbing part; 31. Inner hole; 32. Arc groove; 33. Comb teeth; 34. Storage tank; 4. Rotation direction recognition sensor; 5. Insertion cover; 6. Bearing; 7. Flexible ferrule; 8. Cover; 81. Volatilization hole; 9. Fixed part; 91. Clamping arm; 10. Connecting arm; 101. Clamping groove; 102. Battery.

### DETAILED DESCRIPTION OF THE EMBODIMENTS

In order to make the beneficial effects, technical solutions and technical problems solved by the present application clearer, the present application will be further illustrated in detail with reference to the drawings and embodiments. It should be understood that the specific embodiments described here are merely for illustrating the present application, not for limiting the present application.

It should be understood that the directions or positional relationships indicated by the terms “upper”, “lower”, “left”, “right”, “front”, “back” and “middle” are based on the directions or positional relationships shown in the drawings, only for convenience of describing the present application and simplifying the descriptions, instead of indicating or implying that the device or element must have a specific orientation, be constructed or operated in a specific orientation, and therefore cannot be understood as a limitation of the present application.

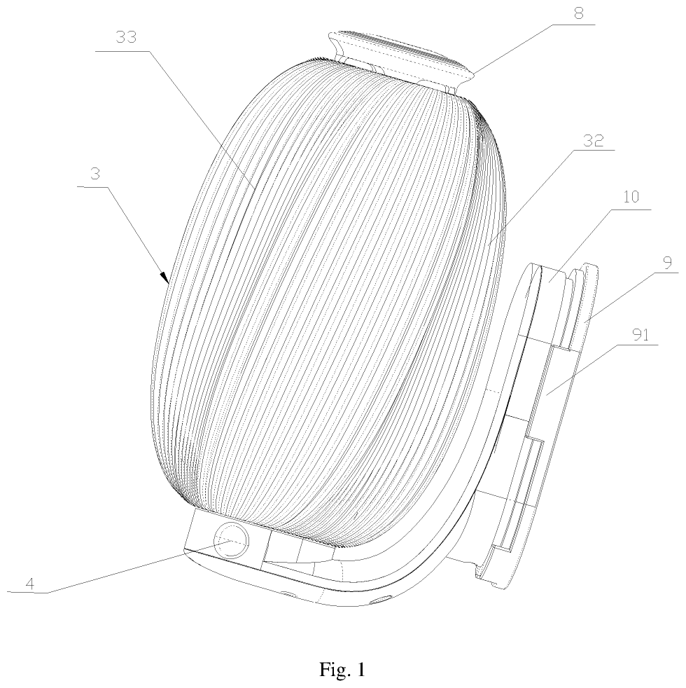

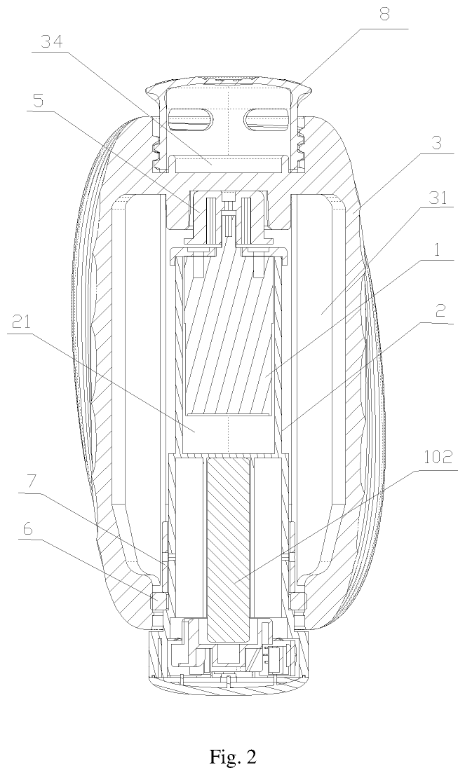

As shown in FIG. 1 and FIG. 2, the rubbing device provided by an embodiment of the present application includes a rotating drive part 1, a mounting post 2 and a rubbing part 3 provided with an inner hole 31; the rubbing part 3 is rotatably installed on the mounting post 2 through the inner hole 31; the rotating drive part 1 is installed on the mounting post 2, positioned in the inner hole 31, and its output end is connected to the rubbing part 3. Understandably, the rotating drive part 1 includes, but is not limited to, rotating motors, etc. The outer surface of the rubbing part 3 may be provided with a convex structure, comb teeth 33, etc. according to actual requirements.

The rotating drive part 1 is used for driving the rubbing part 3 to rotate to rub a to-be-rubbed object when the to-be-rubbed object scratches the rubbing part 3. Understandably, the to-be-rubbed object includes but is not limited to a cat, etc. When the to-be-rubbed object is not rubbing against the rubbing part 3, the rotating drive part 1 would not drive the rubbing part 3 to rotate; when the to-be-rubbed object is rubbing against the rubbing part 3, the rotating drive part 1 would drive the rubbing part 3 to rotate, and the rotating rubbing part 3 would rub and massage the body of the to-be-rubbed object.

In the present application, the rubbing part 3 is rotatably installed on the mounting post 2 through the inner hole 31; and the rotating drive part 1 is installed on the mounting post 2 and positioned in the inner hole 31, and its output end is connected with the rubbing part 3. When the to-be-rubbed object does not scratch the rubbing part 3, the rotating drive part 1 would not drive the rubbing part 3 to rotate; when the to-be-rubbed object scratches the rubbing part 3, the rotating drive part 1 would drive the rubbing part 3 to rotate, and the rotating rubbing part 3 would rub the body of the to-be-rubbed object, thus achieving the functions of rubbing the to-be-rubbed object and relieving the mood of the to-be-rubbed object. In the present application, the rotating drive part 1 can drive the rubbing part 3 to rotate when the to-be-rubbed object scratches the rubbing part 3, so as to better rub the to-be-rubbed object. In addition, the rotating drive part 1 is arranged in the inner hole 31 of the rubbing part 3, and the mounting post 2 can seal the inner hole 31 from the lower end, thus preventing the external environment from damaging the rotating drive part 1 and prolonging the service life of the rubbing device. Moreover, the rubbing device has simple structure and low manufacturing cost.

In an embodiment, as shown in FIG. 1, the rubbing device further includes a rotation direction recognition sensor 4 installed on the mounting post 2; the rotation direction recognition sensor 4 is used to detect a rubbing direction of the to-be-rubbed object relative to the rubbing part 3. Understandably, the rotation direction recognition sensor 4 includes, but is not limited to, pyroelectric infrared sensors, cameras, etc., and the rotation direction recognition sensor 4 can recognize creatures in a certain angle range. The rotation direction recognition sensor 4 is installed below the mounting post 2 and positioned outside the inner hole 31. The number of the rotation direction recognition sensors 4 may be multiple according to the actual requirements, such as two, three, etc., and a plurality of the rotation direction recognition sensors 4 can expand the visual angle of the to-be-rubbed object.

when the rotation direction recognition sensor 4 detects that the to-be-rubbed object scratches the rubbing part 3 in a first direction, the rotating drive part 1 drives the rubbing part 3 to rotate in a second direction; and the first direction is opposite to the second direction. Understandably, when the first direction is clockwise, the second direction is counterclockwise; when the first direction is counterclockwise, the second direction is clockwise.

Specifically, when the rotation direction recognition sensor 4 detects that the to-be-rubbed object rubs the rubbing part 3 in the first direction, the rotating drive part 1 is controlled to drive the rubbing part 3 to rotate in the second direction opposite to the first direction. Therefore, the direction in which the rotating drive part 1 drives the rubbing part 3 to rotate is opposite to the direction in which the to-be-rubbed object drives the rubbing part 3 to rotate, thus the rubbing part 3 can better rub the body of the to-be-rubbed object.

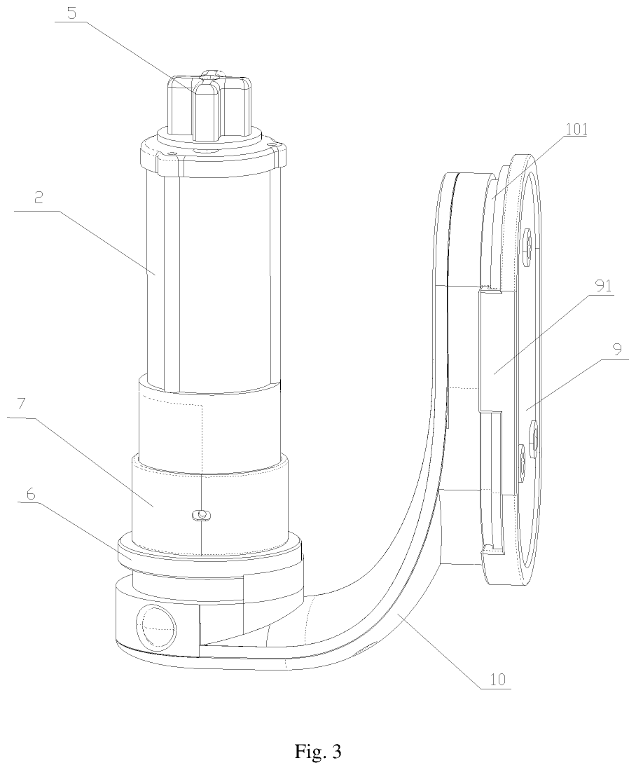

In an embodiment, as shown in FIGS. 2 and 3, the mounting post 2 is provided with a mounting hole 21 and a through hole communicating with the mounting hole 21, the rotating drive part 1 is installed in the mounting hole 21, and the output end of the rotating drive part 1 passes through the through hole and is connected with the rubbing part 3. Understandably, the through hole is positioned at the top of the mounting post 2, and the rubbing part 3 is sleeved on the mounting post 2 through the inner hole 31.

The rubbing part 3 further includes a battery 102 installed in the mounting hole 21, and the battery 102 is electrically connected with the rotating drive part 1. Understandably, the battery 102 is positioned below the mounting hole 21, and the rotating drive part 1 is positioned above the mounting hole 21. In this embodiment, both the rotating drive part 1 and the battery 102 are installed in the mounting hole 21 of the mounting post 2, and the rubbing part 3 is sleeved on the mounting post 2. Thereby further avoiding the interference of external environment on the rotating drive part 1 and the battery 102, further prolonging the service life of the rubbing device and ensuring the rotation stability of the rubbing part 3.

In an embodiment, as shown in FIG. 2 and FIG. 3, the rubbing device further includes an insertion cover 5 installed at the output end of the rotating drive part 1, an inner wall of the inner hole 31 is provided with an insertion slot matched with the insertion cover 5, and the output end of the rotating drive part 1 is connected with the rubbing part 3 through the insertion cover 5 inserted in the insertion slot. Understandably, the insertion slot is arranged on the top inner wall of the inner hole 31, and the insertion cover 5 may be arranged as a polygonal structure according to actual requirements, and the rotating drive part 1 drives the rubbing part 3 to rotate through the insertion cover 5 inserted in the insertion slot. In this embodiment, the assembly and disassembly between the rubbing part 3 and rotating drive part 1 are simple, thus facilitating the cleaning of the rubbing part 3.

In an embodiment, as shown in FIGS. 2 and 3, the rubbing device further includes a bearing 6 and a flexible ferrule 7 sleeved on the mounting post 2, and the rubbing part 3 is rotatably mounted on the mounting post 2 through the bearing 6 and the flexible ferrule 7. Understandably, the bearing 6 is sleeved under the mounting post 2, and the upper part of the mounting post 2 is connected with the rubbing part 3 through the rotating drive part 1, thus improving the stability of the rotating drive part 1 driving the rubbing part 3 to rotate on the mounting post 2. In addition, the flexible ferrule 7 is connected between the outer wall of the mounting post 2 and the inner wall of the inner hole 31, which prevents the bearing 6 from sliding along the mounting post 2. It also ensures the stability of the rubbing part 3 being sleeved on the mounting post 2, improves the convenience of assembly and disassembly between the rubbing part 3 and mounting post 2, thus facilitating the cleaning of the rubbing part 3.

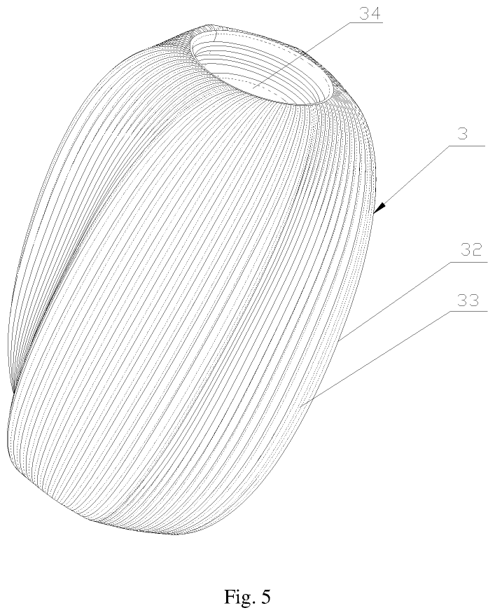

In an embodiment, as shown in FIG. 5, the outer surface of the rubbing part 3 is provided with a plurality of arc grooves 32 distributed at intervals. Understandably, when the rubbing part 3 rotates, the convex structure between two adjacent arc grooves 32 would rub the body of the to-be-rubbed object, thus improving comfort for the to-be-rubbed object when the rubbing part 3 rubs the to-be-rubbed object.

In an embodiment, as shown in FIG. 5, each arc groove 32 is provided with a plurality of comb teeth 33 distributed at intervals. Understandably, the inner wall of the arc groove 32 is provided with a plurality of comb teeth 33 distributed at intervals, so that when the rubbing part 3 and the to-be-rubbed object are relatively rubbed, the comb teeth 33 can remove loose fur shed from the to-be-rubbed object. Therefore, the rubbing part 3 of the present application can not only rub and relive itching for the to-be-rubbed object, but also comb the hair of the to-be-rubbed object, thereby improving the practicability and usability of the rubbing device.

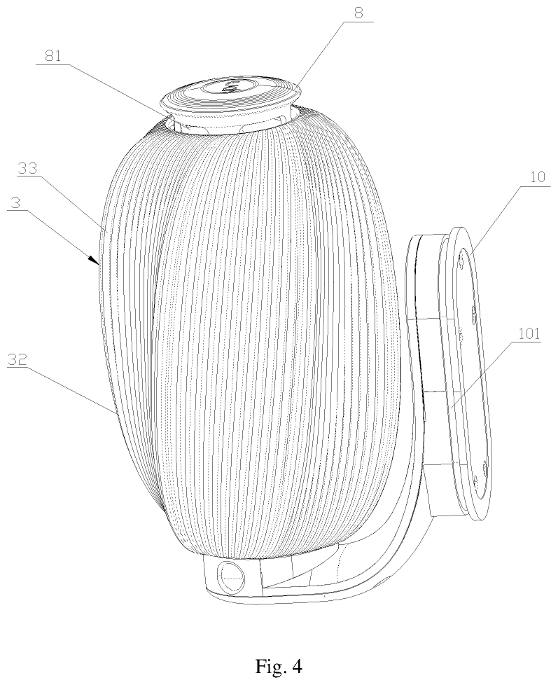

In an embodiment, as shown in FIGS. 4 and 5, the rubbing part 3 is further provided with a storage tank 34, and the rubbing device further includes a cover 8 covering the storage tank 34, and the cover 8 is further provided with a volatilization hole 81 communicating with the storage tank 34. Understandably, the storage tank 34 is arranged at the top of the rubbing part 3, and the storage tank 34 can contain volatile matters such as perfume and aromatherapy. Specifically, when the to-be-rubbed object is a cat, catnip may be stored in the storage tank 34, and the smell of catnip is released through the volatilization hole 81, which stimulates and excites the cat. Catnip is stored in the storage tank 34 at the top of the rubbing part 3, and the storage tank 34 is covered by the cover 8, so as to prevent cat from eating catnip by mistake. When aromatherapy, perfume, etc. are stored in the storage tank 34, aromatherapy, etc. can gives out fragrance to the external environment through the volatilization hole 81, thus playing a role in purifying the air.

In an embodiment, as shown in FIGS. 3 and 4, the rubbing device further includes a fixed part 9 and a connecting arm 10 connected with the mounting post 2, the fixed part 9 is provided with a clamping arm 91, and the connecting arm 10 is provided with a clamping groove 101, and the fixed part 9 is detachably connected with the connecting arm 10 through the clamping arm 91 clamped in the clamping groove 101. Understandably, the connecting arm is connected to the bottom of the mounting post 2, and the connecting arm 10 is positioned outside the inner hole 31; the fixed part 9 may be installed on external fixtures such as walls by screws, glue, etc. Furthermore, the fixed part 9 is provided with a plurality of clamping arms 91 distributed at intervals, and the upper part of the fixed part 9 is provided with an insertion opening, through which a clamping part of the connecting arm 10 can be clamped in the clamping arm 91, and the clamping groove 101 is arranged on the clamping part.

Specifically, firstly, the fixed part 9 is fixedly installed on an external fixture, and the connecting arm 10 is connected to the fixed part 9 through the clamping arm 91 clamped in the clamping groove 101. In this embodiment, the assembly and disassembly between the connecting arm 10 and fixed part 9 are simple, thus improving the convenience of assembly and disassembly of the rubbing device.

Furthermore, the connecting arm 10 is provided with an installation space, and the rubbing device further includes a control board installed in the installation space, and the control board is electrically connected with the battery 102, the rotating drive part 1 and the rotation direction recognition sensor 4. The connecting arm 10 is further provided with a charging interface, the charging interface is electrically connected with the battery 102 through the control board, so that the battery 102 can charged with an external power supply through the charging interface.

The above descriptions are only preferred embodiments of the present application and are not intended to limit the present application. Any modifications, equivalent substitutions and improvements made within the spirit and principle of the present application shall be included in the protection scope of the present application.

What is claimed is:

1. A rubbing device, comprising a rotating drive part, a mounting post and a rubbing part provided with an inner hole; wherein
the rubbing part is rotatably installed on the mounting post through the inner hole; the rotating drive part is installed on the mounting post, positioned in the inner hole, and an output end of the rotating drive part is connected with the rubbing part; and
the rotating drive part is used for driving the rubbing part to rotate to rub a to-be-rubbed object when the to-be-rubbed object scratches the rubbing part.

2. The rubbing device of claim 1, wherein the rubbing device further comprises a rotation direction recognition sensor installed on the mounting post; the rotation direction recognition sensor is used for detecting a rubbing direction of the to-be-rubbed object relative to the rubbing part; and
when the rotation direction recognition sensor detects that the to-be-rubbed object scratches the rubbing part in a first direction, the rotating drive part drives the rubbing part to rotate in a second direction; and the first direction is opposite to the second direction.

3. The rubbing device of claim 1, wherein the mounting post is provided with a mounting hole and a through hole communicating with the mounting hole, the rotating drive part is installed in the mounting hole, and the output end of the rotating drive part passes through the through hole and is connected with the rubbing part; and
the rubbing part further comprises a battery installed in the mounting hole, and the battery is electrically connected with the rotating drive part.

4. The rubbing device of claim 1, wherein the rubbing device further comprises an insertion cover installed at the output end of the rotating drive part, an insertion slot matched with the insertion cover is arranged on an inner wall of the inner hole, and the output end of the rotating drive part is connected with the rubbing part through the insertion cover inserted into the insertion slot.

5. The rubbing device of claim 1, wherein the rubbing device further comprises a bearing sleeved on the mounting post, and the rubbing part is rotatably installed on the mounting post through the bearing.

6. The rubbing device of claim 1, wherein the rubbing device further comprises a flexible ferrule sleeved on the mounting post, and the flexible ferrule is used for preventing the bearing from sliding along the mounting post.

7. The rubbing device of claim 1, wherein an outer surface of the rubbing part is provided with a plurality of arc grooves distributed at intervals.

8. The rubbing device of claim 7, wherein a plurality of comb teeth distributed at intervals are arranged in each arc groove.

9. The rubbing device of claim 1, wherein the rubbing part is further provided with a storage tank, the rubbing device further comprises a cover covering the storage tank, and the cover is further provided with a volatilization hole communicating with the storage tank.

10. The rubbing device of claim 1, wherein the rubbing device further comprises a fixed part and a connecting arm connected with the mounting post, the fixed part is provided with a clamping arm, and the connecting arm is provided with a clamping groove, and the fixed part is detachably connected with the connecting arm through the clamping arm clamped in the clamping groove.
